(19) United States
(12) Patent Application Publication
(10) Pub. No.: US 2024/0039440 A1
(43) Pub. Date: Feb. 1, 2024

(54) METHOD FOR CONTROLLING THE OPERATION OF AN ELECTRIC MACHINE

(71) Applicant: ZF FRIEDRICHSHAFEN AG, Friedrichshafen (DE)

(72) Inventors: Felix BÜHLE, Eriskirch (DE); Hans-Dieter ENDRES, Volkach (DE); Felix LESER, Nüdlingen (DE); Martina JEHLE, Kressbronn (DE); Morteza DJEBELI-SINAKI, Sennfeld (DE); Mario KAMM, Hammelburg (DE)

(21) Appl. No.: 18/227,593

(22) Filed: Jul. 28, 2023

(30) Foreign Application Priority Data
Jul. 29, 2022 (DE) 10 2022 207 862.4

(51) Int. Cl. H02P 21/14; B60L 15/02

(52) U.S. Cl. CPC H02P 21/14; B60L 15/02; B60L 2210/40; B60L 2240/429

(57) ABSTRACT

A method for controlling the operation of an electric machine, particularly an electric machine of a motor vehicle, wherein the electric machine is controlled to generate torque based on alternating current produced by a control device from a direct current supplied by an electrical energy storage. A function current which is determined depending on an actual operating point of the electric machine and which reduces a waviness of the direct current is impressed on the alternating current.

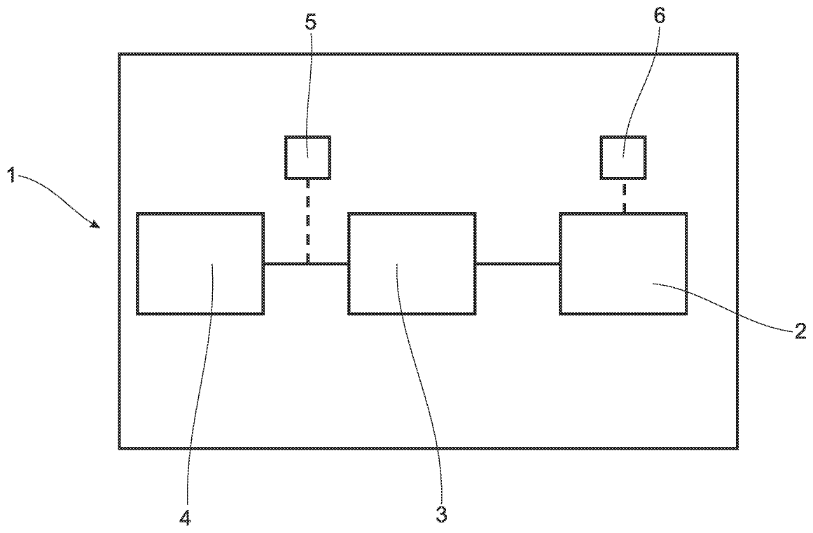

### BACKGROUND OF INVENTION

### 1. Field of the Invention

The disclosure is directed to a method for controlling the operation of an electric machine, particularly an electric machine of a motor vehicle. The electric machine is controlled to generate torque based on alternating current produced by a control device from a direct current supplied by an electrical energy storage.

### 2. Description of Related Art

Methods for controlling the operation of electric machines, for example, electric machines in motor vehicles, are generally known from the prior art. The electric machine is usually operated by an alternating current, or AC current, in order for the electric machine to supply a torque. Electrical energy storages which can supply a direct current are usually provided in motor vehicles, for example, in order to provide energy for operating the electric machine. In a corresponding manner, a control device, for example, an inverter, is provided in the electrical arrangement in the motor vehicle to convert the supplied direct current into alternating currents needed for the operating situation at hand or to generate a required alternating current from the supplied direct current.

Further, it is known from the prior art that generating alternating current from direct current can result in negative effects, for example, the production of harmonics which, for example, can produce (mechanical) oscillation that can adversely affect comfort and the useful life of components of the motor vehicle. In addition, the generation of alternating currents can have an effect on the supplied direct current or on the supplying energy storage, namely, can cause waviness in the direct current, otherwise known as DC ripple, which can also have negative consequences, for example, for the electrical energy storage.

### SUMMARY OF THE INVENTION

An object of one aspect of the invention is to provide an improved method for controlling the operation of an electric machine.

As was described above, one aspect of the invention is directed to a method for controlling the operation of an electric machine, specifically an electric machine of a motor vehicle. The electric machine can be incorporated, for example, in an electrical arrangement such that electrical energy, particularly in the form of supplied direct current, is supplied by an electrical energy storage for the operation of the electric machine. The electrical arrangement can further provide a control device for controlling the operation of the electric machine. The control device can produce alternating current from the supplied direct current, and the alternating current can be supplied to the electric machine in order to operate the electric machine, particularly to generate torque, for example, in order to drive a motor vehicle.

One aspect of the invention is based on the insight that a function current that is determined depending on an actual operating point of the electric machine and which reduces a waviness of the direct current is impressed on the alternating current. In other words, the control device does not produce and supply to the electric machine exclusively that alternating current that is required for operating the electric machine in the actual operating point, for example, that alternating current necessary to produce a determined torque. Instead of this, one aspect of the invention suggests generating a function current in addition to the alternating current described above which is required for achieving or reaching the actual operating point. The function current is selected in such a way that the waviness of the direct current is reduced.

In other words, the operation of the electric machine by generating the alternating current for the actual operating point would produce a defined DC ripple. By additionally impressing the function current, i.e., generating the alternating current and, in addition, the function current, the waviness in the direct current is reduced compared to an operation of the electric machine by exclusive generation of alternating current. The corresponding components of the electric machine, or of the electrical arrangement or motor vehicle generally, can accordingly be better protected against an increased load or untimely damage because the waviness of the direct current can be reduced compared to an operating state in which no function current is generated.

In other words, the function current is selectively generated to reduce the waviness of the direct current, i.e., to attenuate the occurrence of DC ripple. The function current can have a plurality of function parameters, which can be adjusted or modified depending on the actual operating point in order to achieve the optimum possible reduction of waviness for the actual operating point, for example, operation of the electric machine at a determined speed or particular set torque. The alternating current and the function current can be generated via the control device.

As was described above, the function current can basically be defined based on at least one function parameter or plurality of function parameters. According to an embodiment of the method, it can be provided that a function current with a defined function parameter is generated for at least one operating point and, in particular, two function currents with different function parameters are generated for at least two operating points. In general, various parameters, particularly electrical parameters, of the function current are contemplated as function parameters, for example, a frequency, an amplitude, a phase shift in relation to the generated alternating current, direct current parameters of the direct current, for example, the waviness of the direct current or a peak or maximum amplitude of the direct current. Specifically, different function currents can be generated for different operating points of the electric machine so that the function current achieving the best possible reduction of the waviness of the direct current can be impressed in addition to the alternating current in the respective operating point of the electric machine.

According to a further aspect of the method, it can be provided that a set of function parameters is determined for at least one operating point by varying at least one function parameter, particularly by varying the phase and/or amplitude of the function current, based on a detection of the direct current and/or the waviness of the direct current and/or at least one oscillation parameter. According to the described aspect, a set of function parameters comprising at least one function parameter, particularly a plurality of function parameters, can be determined in that at least one of the function parameters is varied and the effects of the function parameter are detected.

For example, the effects of varying the at least one function parameter on the direct current or on the waviness of the direct current or on at least one oscillation parameter can be detected. Accordingly, for example, the phase and/or amplitude of the function current can be varied in such a way that the optimal possible direct current for the operating point is realized. For example, a waviness of the direct current that is as low as possible can be achieved in the operating point. Alternatively, it is also possible to detect at least one mechanical oscillation parameter, for example, an acceleration of a component of the motor vehicle, and to reduce this optimally so that the operation of the electric machine produces as few (mechanical) oscillations as possible in the operating point, for example, does not generate any conspicuous sounds.

Further, the method can be developed such that, in order to determine a set of function parameters in an evaluation run, a function current is generated with a first amplitude and the phase of the function current is changed in the evaluation run, wherein a phase is determined depending on a detection of the direct current and/or depending on the waviness of the direct current, and the amplitude is increased to a second amplitude. Accordingly, one aspect suggests an evaluation run in which the phase of the function current can be varied initially at a first amplitude which can be an amplitude of the function current that is reduced compared to a regular operation. In other words, the phase of the function current is varied initially with a comparatively small amplitude in order to adjust the phase of the function current in such a way that the function current achieves an optimal possible change in the direct current or a reduction of the waviness of the direct current. Subsequently, the amplitude of the function current can be increased to a second amplitude.

The direct current and/or the waviness of the direct current can be detected in an operating state of the electric machine, and at least one function parameter of the function current is determined depending on the detected direct current and/or the detected waviness of the direct current. According to one aspect, a parameter of the direct current or the waviness of the direct current can be detected in an operation of the electric machine, for example, in a driving operation of an electric machine associated with a motor vehicle. The at least one function parameter of the function current can be determined subsequently depending on the detected electrical parameter of the direct current and/or on the detected waviness of the direct current. Accordingly, one aspect makes it possible for an optimum possible reduction of the waviness of the direct current to be achieved in an operation of the electric machine. For example, DC ripple can be actively detected, i.e., deviations of the direct current from a reference shape can be detected. The parameters of the function current can be modified subsequently such that an optimum possible reduction of waviness or adaptation of the direct current can be achieved.

Additionally, at least one oscillation parameter, which describes the acoustic behavior, for example, can be detected. For example, a compromise can be made between a reduction in mechanical oscillations for improving acoustics and a reduction in the waviness of the direct current. As has been described, the at least one oscillation parameter can be detected by a suitable oscillation sensor, for example, an acceleration sensor or a plurality of acceleration sensors. At least one suitable sensor may also be provided for detecting the electrical parameter of the direct current or the direct current itself or the waviness of the direct current.

Similarly, the direct current and/or the waviness of the direct current and an oscillation state of the electric machine can be detected in a test state of the electric machine, particularly on a test stand, and at least one function parameter of the function current can be determined depending on the detected direct current and/or the detected waviness of the direct current and the oscillation state. In this context, the electric machine can be tested or evaluated on a test stand, for example, in the course of “end of line” testing. For example, the direct current that is retrieved from the electrical energy storage or from an electric energy source associated with the test stand by the control device or electric machine can be detected on the test stand. Specifically, the waviness of the direct current can be directly detected or determined from the at least one electrical parameter.

Similarly, the oscillation state of the electric machine can be detected, for example, by suitable oscillation sensors or acceleration sensors. Subsequently, the function parameter of the function current or a set of function parameters of the function current with a plurality of function parameters can be adjusted in such a way that the direct current adopts the desired shape, particularly such that the waviness of the direct current is reduced. In this way, in particular, a suitable compromise can be achieved between a reduction in the waviness of the direct current and a reduction in occurring mechanical vibrations or in the oscillation state of the electric machine.

The described method can be carried out for various operating points that can subsequently be stored, for example, in the control device. The individual operating points can be defined via a plurality of operating parameters, for example, speed and/or torque. Similarly, electrical parameters, for example, a d-current and/or q-current, or the amplitude of the current, a phase shift and further operating parameters can be detected or stored together with the respective function parameters for a determined operating point. Subsequently, the function currents defined therefrom for the individual operating points can be transferred to the control device. If the electric machine is subsequently operated in one of the operating points during operation, the corresponding function currents can be impressed in order to reduce the ripple of the DC current.

Further, it can be provided in the method that at least one function parameter of the function current is determined in a model-based manner. Accordingly, an active detection can be dispensed with, i.e., particularly the direct current or the waviness of the direct current need not be detected but rather can be displayed in a model-based manner. In so doing, a model configured to display the expected waviness of the direct current for an actual operating state can be provided for the electrical arrangement or the electric machine. In other words, the model, particularly a DC ripple model, can display the DC ripple, i.e., the expected waviness, for a determined operating state, for example, the actual operating state.

Correspondingly, the control device can display the function current in such a way and can adjust the function current together with the alternating current of the electric machine in such a way that an optimal reduction in the waviness of the DC current is achieved. The model can be based on various parameters, and it is possible to reduce or expand the level of detail of the model as necessary, for example, by reducing or expanding the parameters. In other words, any number of parameters relating to the electric machine or the electrical arrangement can be provided for the model. Machine parameters of this kind can be, for example, number of pole pairs, electrical parameters, for example, voltage or current, an air gap, losses, for example, copper losses, and the like. Depending on the level of detail of the model, operating points can also be partially stored, that is, different function currents to be displayed can be stored with different operating parameters for the model.

The at least one function parameter of the function current can be determined depending on at least one oscillation parameter of a mechanical oscillation of the electric machine. As was described above, in addition to the adjustment of the electrical parameter of the direct current, particularly the reduction in the waviness of the direct current, influence can also be exerted on mechanical oscillations of the electric machine. To this end, the function current can be determined additionally depending on at least one oscillation parameter of the electric machine. Specifically, therefore, a best point from an expected oscillation state or expected acoustics and a waviness of the direct current can be achieved. For example, the mechanical oscillations of the electric machine during operation as well as the occurring ripple can be reduced as far as possible. For example, mechanical oscillations can be reduced so as to fall under a comfort criterion. A limit value can also be defined for the waviness of the DC current, below which the waviness is adjusted.

In addition to the method, the invention is directed to a drive arrangement for a motor vehicle, comprising a control device, an electrical energy storage configured to provide direct current and an electric machine. The control device is configured to control the electric machine to generate torque based on alternating current generated from the direct current. The control device is configured to impress a function current determined depending on an actual operating point of the electric machine on the alternating current, which function current reduces a waviness of the direct current. The invention is further directed to a motor vehicle comprising such a drive arrangement.

All of the advantages, details and features which have been described in relation to the method are completely transferable to the drive arrangement and the motor vehicle. The method can be implemented in particular with the drive arrangement or on the drive arrangement. Specifically, the control device of the drive arrangement is configured to implement the method described above.

### BRIEF DESCRIPTION OF THE DRAWINGS

The invention will be described in the following referring to an embodiment example shown in the drawing.

The drawing is a schematic depiction of a drive arrangement.

### DETAILED DESCRIPTION OF THE PRESENTLY PREFERRED EMBODIMENTS

The drawing shows a schematic diagram of a drive arrangement 1, for example, for a motor vehicle. Accordingly, a corresponding motor vehicle can have the drive arrangement 1. The drive arrangement 1 has an electric machine 2 which, for example, is formed as a traction drive for the motor vehicle or is used as a traction drive in the drive arrangement 1. In particular, this means that the electric machine 2 can be used to generate torque that can be utilized, for example, for the propulsion of the motor vehicle. The drive arrangement 1 further has a control device 3, which can be constructed, for example, as an inverter. The control device 3 controls the operation of the electric machine 2 by generating an alternating current. In other words, depending on an actual operating state or operating point of the electric machine 2, the control device 3 can generate a corresponding alternating current and supply it to the electric machine 2.

In order to provide energy, the drive arrangement 1 has an electrical energy storage 4 supplying the direct current. In other words, the control device 3 can be supplied with direct current from the electrical energy storage 4 to generate alternating current for controlling the electric machine 2. Further, the control device 3 is configured to generate a function current in addition to the alternating current and to supply it to the electric machine 2. The function current is selected such that a waviness of the direct current or DC current which is provided by the electrical energy storage 4 is reduced relative to an operating state of the drive arrangement 1 in which only the alternating current is generated.

In other words, “alternating current” refers to that part of the output signal of the control device 3 to the electric machine 2 that is required for achieving the desired operating state, for example, to adopt a defined operating point of the electric machine 2 that defines itself, for example, from a determined speed and/or a determined torque. In addition to this, the function current which ultimately has no influence on the operating state but reduces the waviness or DC ripple in the direct current provided by the electrical energy storage 4 is outputted.

The described function current can be adjusted in any desired manner in principle, for example, as any component or combination of d-current and/or q-current, for example, comprising exclusively d-current or q-current. To this end, for example, the control device 3 can also adjust one or more function parameters of the function current, for example, the phase, amplitude or frequency thereof. As has been described, a function current can be generated for at least one operating point of the electric machine 2. Specifically, two different function currents, i.e., function currents with different function parameters or different sets of function parameters, can be generated for at least two operating points. In this regard, any number of operating points and/or function currents can be formed in principle and stored in the control device 3 so that the control device 3 generates the appropriate function current and can supply it to the electric machine 2.

In order to find the correct function current or function parameter for an operating point, at least one function parameter of a set of function parameters of the function current can be varied, for example. For example, the phase and/or the amplitude of the function current can be varied. The effects of generating the function current can be detected by suitable sensors. For example, detection can be carried out during operation or on a test stand. The drive arrangement 1 can be coupled with various sensors for this purpose or can have such sensors. By way of example, a current sensor 5 is shown, which is configured to detect at least one electrical parameter of the direct current, for example, the direct current itself and/or the waviness of the direct current. Accordingly, it can be determined whether or not impressing the function current in addition to the alternating current achieves the desired effect, that is, whether or not the waviness of the direct current is reduced in the desired manner by the adjusted function current.

Optionally, an oscillation sensor 6 or a plurality of oscillation sensors can be provided, for example, in the form of an acceleration sensor, which can be coupled with the electric machine 2. For example, such oscillation sensors 6 can be provided on a test stand and can determine which mechanical oscillations are generated or excited by the electric machine 2 in various operating points of the electric machine 2. The generated oscillations can also be determined in relation to the generated function current. Specifically, a best point can be found at which the best possible reduction of the waviness of the DC current and lowest possible excitation of mechanical oscillations or reduction of mechanical oscillations is achieved.

An evaluation run in which a set of function parameters for the function current is determined for at least one operating point can be carried out, for example, on a test stand or in an operating state of the drive arrangement 1. The evaluation run may be repeated for a plurality of operating points of the electric machine 2, for example, various speeds and/or torques. The results of the evaluation run can be stored in the control device 3 and correspondingly retrieved when an operating point is occupied by the electric machine 2 so that the function current stored for the operating point can be adjusted.

During the evaluation run, the function current can initially be generated with a first amplitude which can be comparatively low in order to minimize as far as possible the effects of impressing the function current. Subsequently, the phase of the function current can be changed in the evaluation run, and the effects of impressing the function current can be detected. As has already been described, the at least one electrical parameter of the direct current and/or the waviness of the direct current can be detected, for example. The changes or effects of the function current on the oscillation state of the electric machine 2 can also be detected. If a suitable set of function parameters is found for the function current, the first amplitude can be increased or reduced to a second amplitude for this operating point in order to strengthen the effect of the function current or to select the desired amplitude.

In addition to the direct detection of effects or the direct detection of the direct current or of oscillations by the current sensor 5 or by the oscillation sensor 6, respectively, the at least one function parameter of the function current can also be determined based on a model. To this end, a model of the waviness of the direct current can be stored on the control device 3. Accordingly, the model can display the expected waviness of the direct current for various operating states of the electric machine 2 so that the control device 3 is capable of adjusting the at least one function parameter of the function current in such a way that a desired reduction of waviness is achieved. The method described herein can be implemented on the drive arrangement 1. The description is transferrable in a corresponding manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for controlling operation of an electric machine, comprising:
controlling the electric machine to generate torque based on alternating current produced by a control device from a direct current supplied by an electrical energy storage; and
determining a function current depending on an actual operating point of the electric machine and which reduces a waviness of the direct current is impressed on the alternating current.

2. The method according to claim 1, wherein a function current with a defined function parameter is generated for at least one operating point.

3. The method according to claim 1, wherein a set of function parameters is determined for at least one operating point by varying at least one function parameter.

4. The method according to claim 1, wherein in order to determine a set of function parameters in an evaluation run, a function current is generated with a first amplitude and a phase of the function current is changed in the evaluation run, wherein a phase is determined depending on a detection of the direct current and/or depending on a waviness of the direct current, and its amplitude is increased to a second amplitude.

5. The method according to claim 4, wherein the direct current and/or the waviness of the direct current is detected in an operating state of the electric machine, and at least one function parameter of the function current is determined depending on the detected direct current and/or the detected waviness of the direct current.

6. The method according to claim 4, wherein the direct current and/or the waviness of the direct current and an oscillation state of the electric machine are detected in a test state of the electric machine, particularly on a test stand, and at least one function parameter of the function current is determined depending on the detected direct current and/or the detected waviness of the direct current and the oscillation state.

7. The method according to claim 1, wherein at least one function parameter of the function current is determined in a model-based manner.

8. The method according to claim 7, wherein the at least one function parameter of the function current is determined depending on at least one oscillation parameter of a mechanical oscillation of the electric machine.

9. A drive arrangement for a motor vehicle, comprising:
a control device; and
an electrical energy storage configured to provide direct current and an electric machine,
wherein the control device is configured to control the electric machine to generate torque based on alternating current generated from the direct current,
wherein the control device is configured to impress a function current determined depending on an actual operating point of the electric machine on the alternating current, which function current reduces a waviness of the direct current.

10. Motor vehicle comprising:
a drive arrangement comprising:
a control device; and
an electrical energy storage configured to provide direct current and an electric machine,
wherein the control device is configured to control the electric machine to generate torque based on alternating current generated from the direct current,
wherein the control device is configured to impress a function current determined depending on an actual operating point of the electric machine on the alternating current, which function current reduces a waviness of the direct current.

11. The method according to claim 1, wherein the electric machine is an electric machine of a motor vehicle.

12. The method according to claim 1, wherein two function currents with different function parameters are generated for at least two operating points.

13. The method according to claim 3, wherein the at least one function parameter that is varied is one or more of a phase and/or amplitude of the function current, based on a detection of the direct current and/or a waviness of the direct current and/or at least one oscillation parameter.
